(19) United States
(12) Patent Application Publication
(10) Pub. No.: US 2021/0152258 A1
(43) Pub. Date: May 20, 2021

(54) ELECTRODE DEVICE

(71) Applicant: SONY SEMICONDUCTOR SOLUTIONS CORPORATION, KANAGAWA (JP)

(72) Inventors: MASAHIRO UNO, TOKYO (JP); MASAYUKI TANAKA, KANAGAWA (JP); SHINICHI FUKUDA, KANAGAWA (JP)

(21) Appl. No.: 16/628,106

(22) PCT Filed: Apr. 24, 2018
(86) PCT No.: PCT/JP2018/016532

§ 371 Date: Jan. 2, 2020

(30) Foreign Application Priority Data
Jul. 11, 2017 (JP) 2017-135396

(51) Int. Cl. H04B 13/00; H04W 4/80

(52) U.S. Cl. CPC H04B 13/005; H04W 4/80

(57) ABSTRACT

To suppress occurrence of communication not intended by the user while improving ease of introduction regarding an electrode device. An electrode device including a conductive plate, a first electrode plate provided in parallel with the conductive plate and spaced apart from the conductive plate in the thickness direction of the conductive plate, and a second electrode plate provided in parallel with the conductive plate, at a location not overlapping with the first electrode plate in the planar direction of the conductive plate.

### TECHNICAL FIELD

The present disclosure relates to an electrode device.

### BACKGROUND ART

In recent years, research on a human body communication system also called body area network (BAN) has been advanced. The human body communication system includes a plurality of terminals brought close to the user's human body. Each terminal has at least two sheets of electrodes, and when a terminal that the user wears generates a potential difference between the two sheets of electrodes, an electric field distribution is generated on the surface of the user's human body. Due to contact between the user having an electric field distribution and another terminal, or spatial coupling between terminals, a potential difference occurs between the two sheets of electrodes of the other terminal, the other terminal extracts a signal from the potential difference, and thus human body communication (electric field communication) can be realized.

Patent Document 1 discloses a system in which human body communication is used to manage entry/exit of a user. The system can control opening and closing of a door through communication between a terminal installed on a door and a portable terminal carried by the user.

### CITATION LIST

### Patent Document

Patent Document 1: Japanese Patent Application Laid-Open No. 2011-205319

### SUMMARY OF THE INVENTION

### Problems to be Solved by the Invention

However, in the human body communication system, there may be a case where communication not intended by the user is performed. Patent Document 1 proposes a technique for limiting the reachable range of an electric field by using a metal plate wider than the width of the user. However, use of a metal plate wider than the width of the user leads to an increase in the scale of the system.

Therefore, the present disclosure proposes a new and improved electrode device that can improve suppress the occurrence of communication not intended by the user while improving the ease of introduction.

### Solution to Problems

According to the present disclosure, there is provided an electrode device including a conductive plate, a first electrode plate provided in parallel with the conductive plate and spaced apart from the conductive plate in the thickness direction of the conductive plate, and a second electrode plate provided in parallel with the conductive plate, at a location not overlapping with the first electrode plate in the planar direction of the conductive plate.

### Effects of the Invention

As described above, according to the present disclosure, it is possible to suppress the occurrence of communication not intended by the user while improving the ease of introduction.

Note that the effects described above are not necessarily limited, and together with or in lieu of the effects described above, any of the effects described in the present description, or other effects that can be grasped from the present description may be exhibited.

### BRIEF DESCRIPTION OF DRAWINGS

FIG. 1 is an explanatory view illustrating a configuration of a human body communication system.

FIG. 2 is an explanatory view illustrating a configuration of a wearable terminal 20.

FIG. 3 is a plan view and a side view of an installed terminal 10-1 according to a first embodiment.

FIG. 4 is a simulation result illustrating an equipotential surface in a case where a spatial electric field is formed around a terminal according to a comparative example having no conductive plate 102.

FIG. 5 is a simulation result illustrating an equipotential surface in a case where a spatial electric field is formed around the installed terminal 10-1 according to the first embodiment having the conductive plate 102.

FIG. 6 is a simulation result illustrating an equipotential surface in a case where a spatial electric field is formed around the installed terminal 10-1 according to the first embodiment having the conductive plate 102.

FIG. 7 is a simulation result illustrating an equipotential surface in a case where a spatial electric field is formed around the installed terminal 10-1 according to the first embodiment having the conductive plate 102.

FIG. 8 is an explanatory view illustrating a human body communication system according to a second embodiment.

FIG. 9 is an explanatory view illustrating the human body communication system according to the second embodiment.

FIG. 10 is a plan view and a side view of an installed terminal 10-2 according to the second embodiment.

FIG. 11 is a simulation result illustrating an equipotential surface in a case where a spatial electric field is formed around the installed terminal 10-2 according to the second embodiment.

FIG. 12 is an explanatory diagram illustrating the relationship between the positional relationship between the installed terminal 10-2 and the wearable terminal 20 and throughput realized by BAN communication.

FIG. 13 is an explanatory view illustrating a first modification.

FIG. 14 is an explanatory view illustrating a second modification.

### MODE FOR CARRYING OUT THE INVENTION

Hereinafter, preferred embodiments of the present disclosure will be described in detail with reference to the accompanying drawings. Note that in the present description and the drawings, constituents having substantially the same functional configuration are denoted by the same reference signs and thus redundant description will be omitted.

Furthermore, in the present description and the drawings, there are cases where a plurality of constituents having substantially the same functional configuration is distinguished by attaching different alphabets after the same reference signs. However, in a case where there is no need to particularly distinguish each of a plurality of constituents having substantially the same functional configuration, only the same reference sign is given to each of the plurality of constituents.

Furthermore, the present disclosure will be described according to the item order indicated below.

0. Overview of human body communication system

1. First Embodiment

2. Second Embodiment

3. Modification

4. Conclusion

<0. Overview of Human Body Communication System>

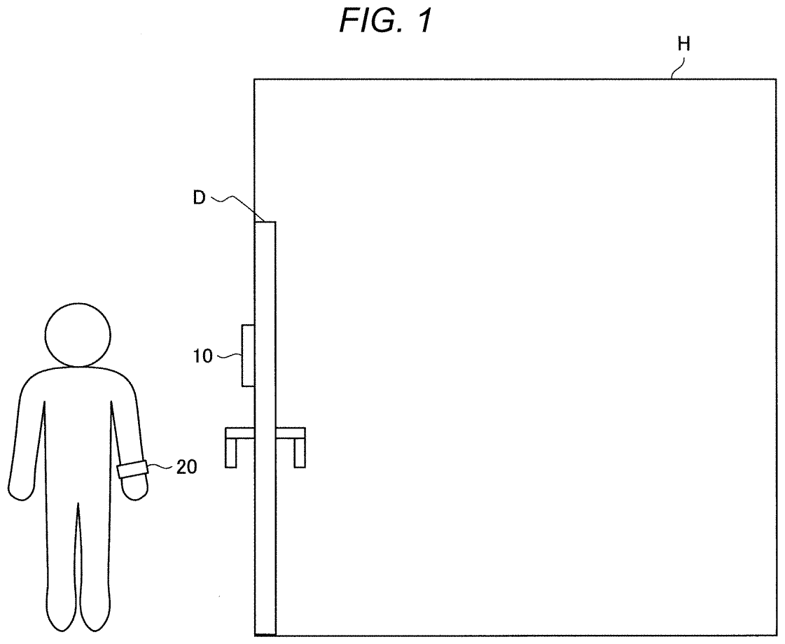

An embodiment of the present disclosure is applied to a human body communication system also called a body area network (BAN). BAN communication (human body communication) between terminals in the human body communication system is realized by causing electrodes provided on a terminal to distribute an electric field on a human body surface. Hereinafter, a specific configuration example of such a human body communication system will be described with reference to FIG. 1.

FIG. 1 is an explanatory view illustrating a configuration of a human body communication system. FIG. 1 illustrates a human body communication system including an installed terminal 10 and a wearable terminal 20.

The installed terminal 10 is an example of an electrode device having at least two sheets of electrodes, and is installed on a door D of a building H in the example illustrated in FIG. 1. The installed terminal 10 also includes a communication processing unit such as a reception processing unit that extracts a reception signal from a potential difference generated between the two sheets of electrodes, and a transmission processing unit that generates a potential difference between the two sheets of electrodes as a signal transmission process. The system of human body communication is not particularly limited, and for example, ISO/IEC 17982 (Close Capacitive Coupling Communication, CCCC) standard may be applied.

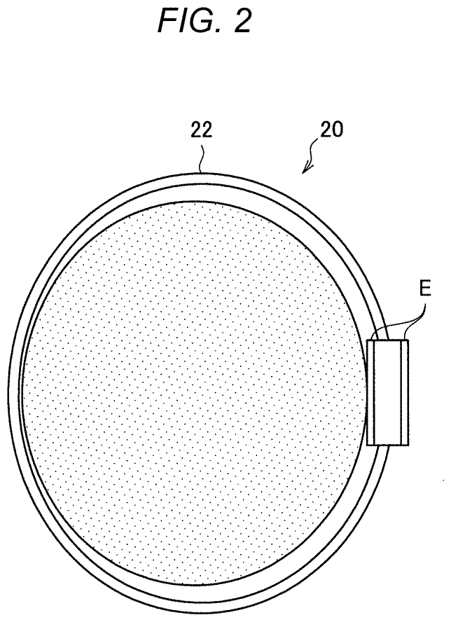

The wearable terminal 20 is a wristband-type communication device. As illustrated in FIG. 2, the wearable terminal 20 includes a band unit 22 worn on a wrist or an arm and two sheets of electrodes E. BAN communication using the electrodes E is realized by causing the electrodes E to generate an electric field on the human body or inducing a reception signal indicating a change in the electric field generated on the human body in the electrodes E.

Note that the two sheets of electrodes E are typically configured of parallel plates. The sizes of the two sheets of electrodes E may be the same or different. Furthermore, the central axes of the two sheets of electrodes E may be the same or different. Furthermore, the shape of the electrode E is not particularly limited. For example, the shape of the electrode E may be rectangular, circular, or a more complicated shape. Furthermore, the wearable terminal 20 is only an example of a communication device, and a portable terminal carried by a user is also applicable as the communication device. Furthermore, the system of human body communication is not particularly limited, and for example, ISO/IEC 17982 (Close Capacitive Coupling Communication, CCCC) standard may be applied.

When the user wearing the above-described wearable terminal 20 touches the electrode of the installed terminal 10, BAN communication between the wearable terminal 20 and the installed terminal 10 is realized via the user's human body. When a predetermined communication sequence is successful through the BAN communication, the installed terminal 10 drives, for example, an actuator, not illustrated, to control locking or unlocking of the key of the door D.

Here, if the wearable terminal 20 generates an electric field on the human body, a spatial electric field is formed around the wearable terminal 20. For this reason, if the two sheets of electrodes of the installed terminal 10 are configured of two sheets of plate electrodes facing each other as illustrated in FIG. 2, when the user approaches the installed terminal 10, the wearable terminal 20 and installed terminal 10 can be spatially coupled to each other even though the user does not touch the electrode of the installed terminal 10. As a result, there is a concern that BAN communication is performed between the wearable terminal 20 and the installed terminal 10 and locking or unlocking of the door D not intended by the user will be performed.

The inventor of the present invention has created an installed terminal 10-1 according to a first embodiment of the present disclosure by focusing on the circumstances described above. The installed terminal 10-1 according to the first embodiment has an electrode configuration that can suppress the occurrence of BAN communication not intended by the user. Hereinafter, the description of the configuration of the installed terminal 10-1 according to the first embodiment will be continued.

### 1. First Embodiment

(Configuration)

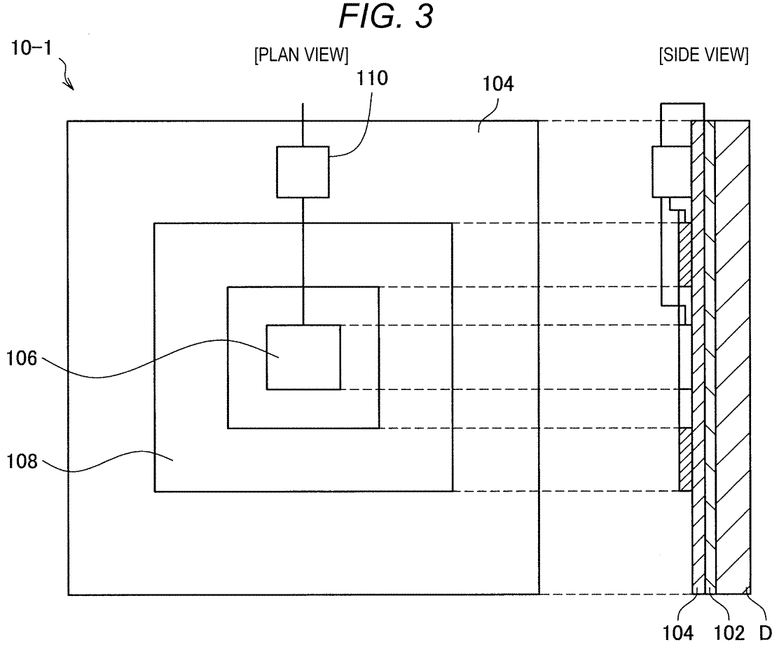

FIG. 3 is a plan view and a side view (cross-sectional view) of the installed terminal 10-1 according to the first embodiment. As illustrated in FIG. 3, the installed terminal 10-1 according to the first embodiment includes a conductive plate 102, an insulating plate 104, a first electrode plate 106, a second electrode plate 108, and a communication processing unit 110.

The conductive plate 102 is a flat plate having conductivity. The conductive plate 102 may be a metal such as copper, aluminum, nickel or an alloy. An insulating plate 104 is laminated on the conductive plate 102 as illustrated in FIG. 3.

Moreover, the first electrode plate 106, the second electrode plate 108, and the communication processing unit 110 are formed on the insulating plate 104. As illustrated in FIG. 1, the first electrode plate 106 and the second electrode plate 108 are provided in parallel with the conductive plate 102. The first electrode plate 106 and the second electrode plate 108 have the same thickness, and are provided at the same location in the thickness direction of the installed terminal 10-1 (that is, the thickness direction of the conductive plate 102).

The first electrode plate 106 and the second electrode plate 108 are provided at locations that do not overlap with each other in plan view of the installed terminal 10-1. In the example illustrated in FIG. 1, the first electrode plate 106 has a square shape and the second electrode plate 108 has a shape surrounding the first electrode plate 106 in plan view of the installed terminal 10-1. For example, the length of one side of the first electrode plate 106 may be 10 mm, one side of the outer periphery of the second electrode plate 108 may be 40 mm, and one side of the inner periphery of the second electrode plate 108 may be 20 mm. In the present embodiment, the plane area of the conductive plate 102 is preferably larger than the area of the first electrode plate 106 and the area of the second electrode plate 108. For example, the plane of the conductive plate 102 may be a rectangle having a long side of 140 mm and a short side of 70 mm. In this case, the first electrode plate 106 and the second electrode plate 108 can be positioned within the range of the plane of the conductive plate 102.

The communication processing unit 110 is configured to perform a signal process for BAN communication, and is electrically connected to the first electrode plate 106, the second electrode plate 108, and the conductive plate 102. The communication processing unit 110 includes, for example, a central processing unit (CPU), a modem unit (PHY, MAC), a transmission processing unit, a reception processing unit, and the like. The modem unit modulates transmission data supplied from the CPU to generate a modulating signal, and the transmission processing unit applies the modulating signal to the first electrode plate 106 and the second electrode plate 108 in a predetermined frequency band, and thus signal transmission is realized. Furthermore, the signals input from the first electrode plate 106 and the second electrode plate 108 are subjected to a reception process such as amplification and down conversion, the modem unit demodulates reception data from the signals subjected to the reception process, and thus signal reception is realized.

(Operation and Effect)

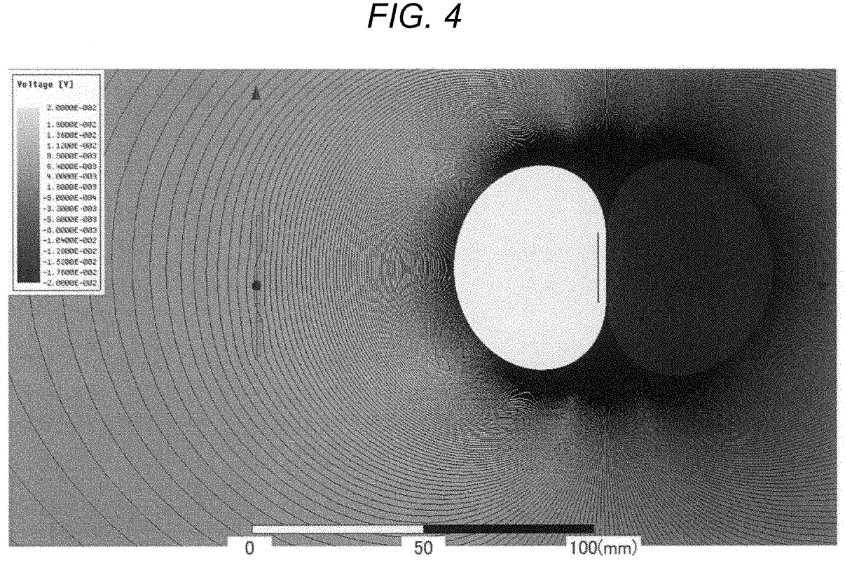

Next, with reference to FIGS. 4 to 7, the operation and effect of the installed terminal 10-1 according to the first embodiment will be described.

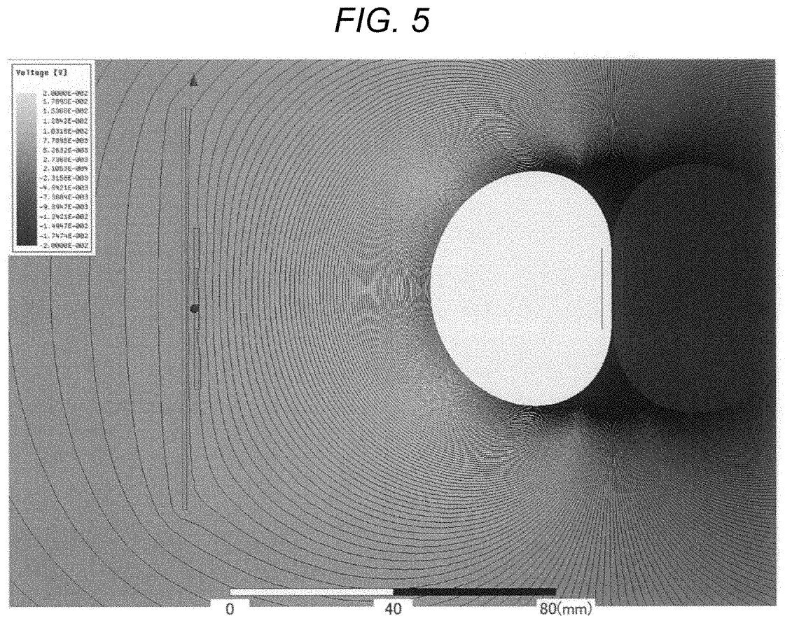

As described above, the installed terminal 10-1 according to the first embodiment includes the first electrode plate 106 and the second electrode plate 108 on the same plane. For this reason, in a case where a spatial electric field is formed by the wearable terminal 20 facing the installed terminal 10-1, the potential difference generated between the first electrode plate 106 and the second electrode plate 108 can be made smaller than the potential difference generated between two sheets of electrode plates having the same central axis. However, only by providing the first electrode plate 106 and the second electrode plate 108 on the same plane, a potential difference which is not small is generated between the first electrode plate 106 and the second electrode plate 108, and as a result, spatial coupling can occur. In contrast, the installed terminal 10-1 according to the first embodiment has the conductive plate 102 wider than the first electrode plate 106 and the second electrode plate 108, and thus it is possible to further reduce the potential difference between the first electrode plate 106 and the second electrode plate 108. Hereinafter, this point will be described with reference to FIGS. 4 and 5.

FIG. 4 is a simulation result illustrating an equipotential surface in a case where a spatial electric field is formed around a terminal according to a comparative example having no conductive plate 102. As illustrated in FIG. 4, in a spatial electric field formed by a wearable terminal 20 facing the terminal according to the comparative example, an equipotential surface exists between a first electrode plate 106 and a second electrode plate 108. That is, a potential difference is generated between the first electrode plate 106 and the second electrode plate 108. As a result, BAN communication can be performed by spatial coupling.

FIG. 5 is a simulation result illustrating an equipotential surface in a case where a spatial electric field is formed around the installed terminal 10-1 according to the first embodiment having the conductive plate 102. As illustrated in FIG. 5, in the installed terminal 10-1 according to the first embodiment, the equipotential surface is pulled toward the conductive plate 102. As a result, the same equipotential surface is in contact with the first electrode plate 106 and the second electrode plate 108. That is, since the potentials of the first electrode plate 106 and the second electrode plate 108 are the same, there is no potential difference between the first electrode plate 106 and the second electrode plate 108.

As described above, according to the first embodiment, spatial coupling between the installed terminal 10-1 and the wearable terminal 20 is less likely to occur. Therefore, it is possible to suppress the occurrence of BAN communication not intended by the user in a case where the user wearing the wearable terminal 20 approaches the installed terminal 10-1.

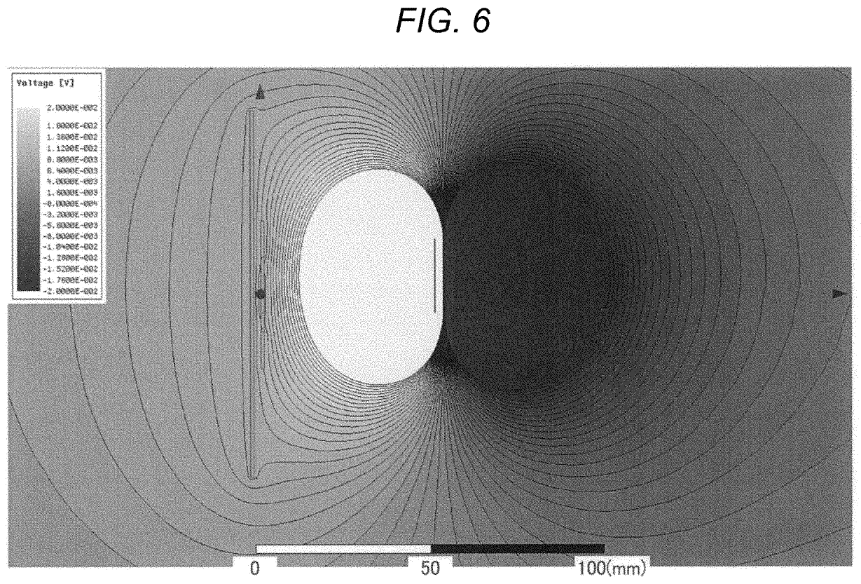

In contrast, as illustrated in FIG. 6, if the distance between the installed terminal 10-1 and the wearable terminal 20 becomes as close as 50 mm, an equipotential surface exists between the first electrode plate 106 and the second electrode plate 108. That is, a potential difference is generated between the first electrode plate 106 and the second electrode plate 108. Therefore, the installed terminal 10-1 and the wearable terminal 20 are spatially coupled to each other, and BAN communication is realized. In a case where the distance between the installed terminal 10-1 and the wearable terminal 20 is as close as 50 mm, it is considered that the user intentionally brings the wearable terminal 20 closer to the installed terminal 10-1. Therefore, it can be said that realization of BAN communication at the distance is in accordance with the user's intention.

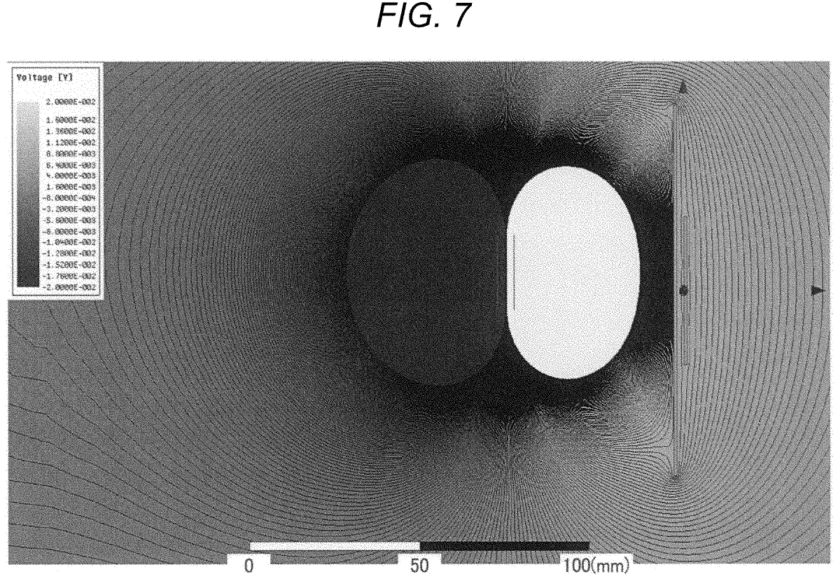

Note that even if the wearable terminal 20 is brought close to the installed terminal 10-1 from the back side of the installed terminal 10-1, as illustrated in FIG. 7, the same equipotential surface is brought into contact with the first electrode plate 106 and the second electrode plate 108. Thus, BAN communication is not performed. That is, according to the present embodiment, it is possible to limit the condition for starting BAN communication to proximity of the wearable terminal 20 on the front side of the installed terminal 10-1.

(Conclusion of First Embodiment)

As described above, according to the first embodiment of the present disclosure, spatial coupling between the installed terminal 10-1 and the wearable terminal 20 is less likely to occur. Therefore, it is possible to suppress the occurrence of BAN communication not intended by the user in a case where the user wearing the wearable terminal 20 approaches the installed terminal 10-1.

### 2. Second Embodiment

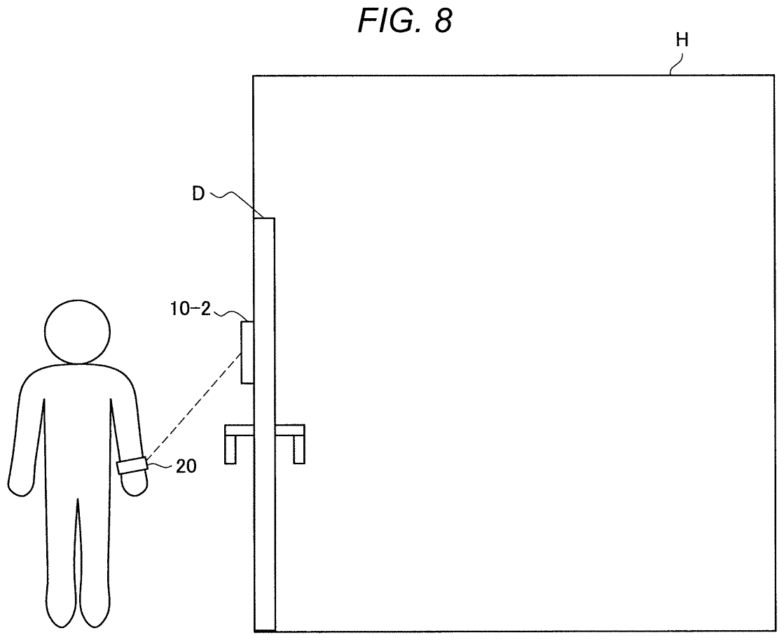

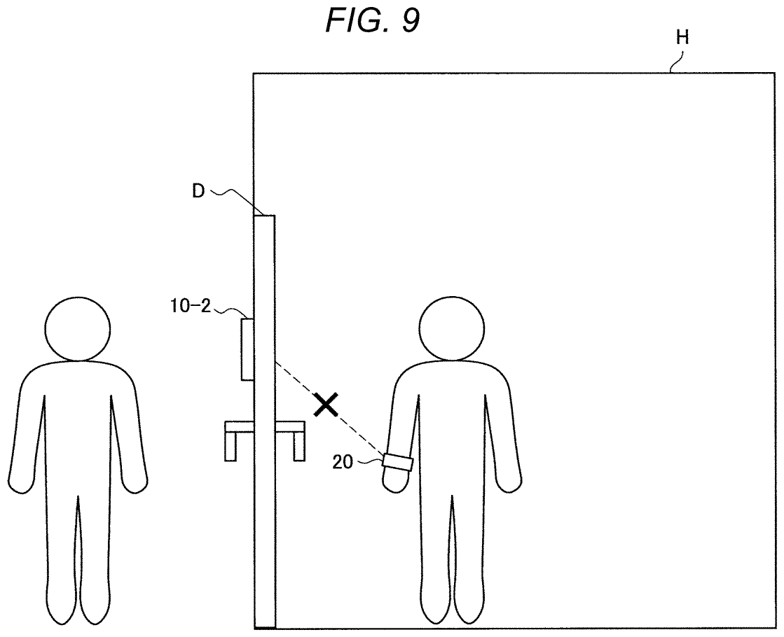

Next, a second embodiment of the present disclosure will be described. The second embodiment differs from the first embodiment in that the second embodiment has a configuration of facilitating spatial coupling. First, the background of the second embodiment will be described with reference to FIGS. 8 and 9.

FIG. 8 is an explanatory view illustrating a human body communication system according to the second embodiment. As illustrated in FIG. 8, the human body communication system according to the second embodiment includes an installed terminal 10-2 and a wearable terminal 20.

As illustrated in FIG. 8, the installed terminal 10-2 is configured so as to be able to be spatially coupled to the wearable terminal 20 even in a state where a user wearing the wearable terminal 20 is not touching the installed terminal 10-2. In such a configuration, since BAN communication is started without the user performing any special operation, user convenience is improved.

However, as described in “0. Overview of human body communication system” and the like, occurrence of BAN communication not intended by the user is not preferable. For this reason, as illustrated in FIG. 9, the installed terminal 10-2 according to the second embodiment is configured so as not to be spatially coupled to the wearable terminal 20 even if the user wearing the wearable terminal 20 approaches the installed terminal 10-2 from inside the building H. With such a configuration, it is possible to prevent a door D from being unlocked without the user's intention and to prevent a malicious third party from entering a building H through the unlocked door D.

Hereinafter, the configuration of such the installed terminal 10-2 according to the second embodiment will be described more specifically.

(Configuration)

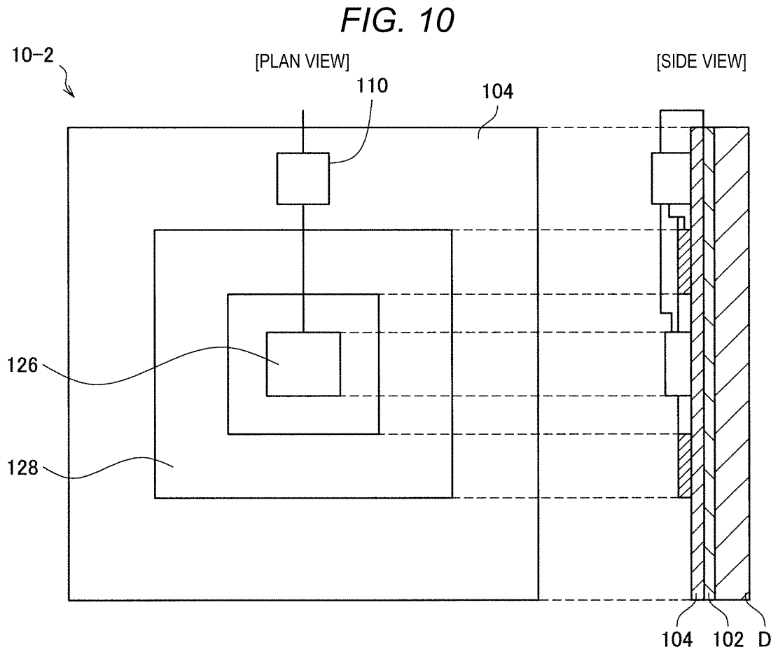

FIG. 10 is a plan view and a side view of the installed terminal 10-2 according to the second embodiment. As illustrated in FIG. 10, the installed terminal 10-2 according to the second embodiment includes a conductive plate 102, an insulating plate 104, a first electrode plate 126, a second electrode plate 128, and a communication processing unit 110. Since the configurations of the conductive plate 102, the insulating plate 104, and the communication processing unit 110 are the same as those described in the first embodiment, a detailed description of the configurations of the conductive plate 102, the insulating plate 104, and the communication processing unit 110 will be omitted.

The first electrode plate 126 and the second electrode plate 128 are provided at locations that do not overlap with each other in plan view of the installed terminal 10-2. In addition, the configurations of the first electrode plate 106 and the second electrode plate 108 described in the first embodiment can be applied to the configuration of the first electrode plate 126 and the second electrode plate 128 in plan view.

Furthermore, the first electrode plate 126 and the second electrode plate 128 are provided in parallel with the conductive plate 102 in the same manner as the first electrode plate 106 and the second electrode plate 108 described in the first embodiment. In contrast, as illustrated in the side view of FIG. 10, the thickness of the first electrode plate 126 and the thickness of the second electrode plate 128 differ from each other, and the first electrode plate 126 and the second electrode plate 128 are provided at locations overlapping with each other in the thickness direction of the installed terminal 10-2. In the example illustrated in FIG. 10, the thickness of the first electrode plate 126 is thicker than the thickness of the second electrode plate 128.

(Operation and Effect)

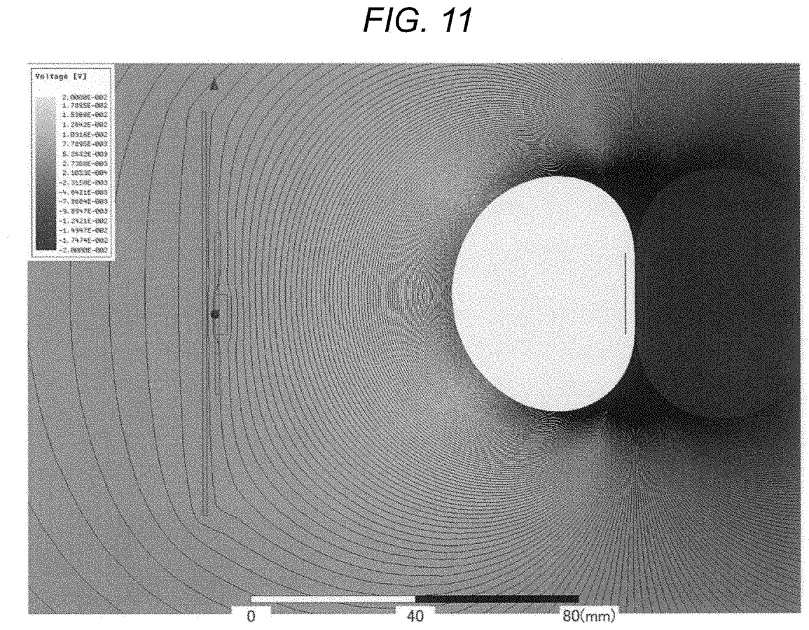

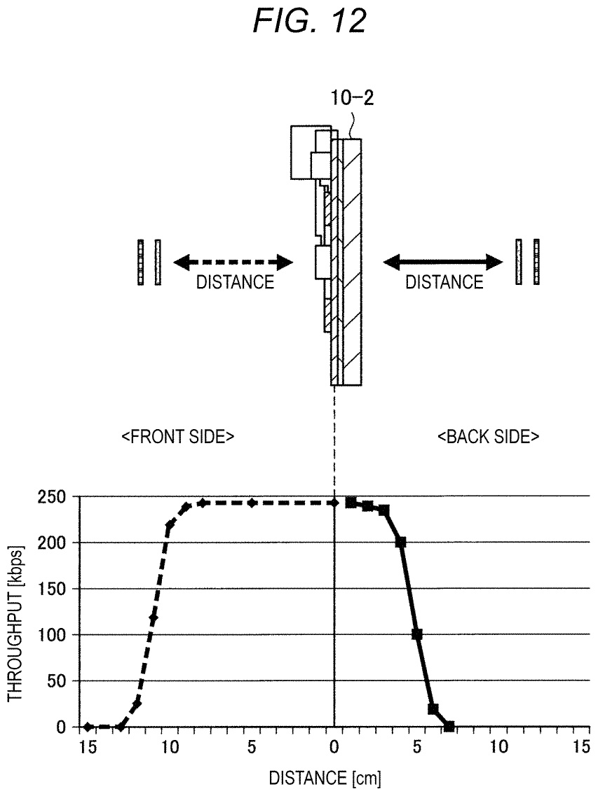

Next, with reference to FIGS. 11 and 12, the operation and effect of the installed terminal 10-2 according to the second embodiment will be described.

FIG. 11 is a simulation result illustrating an equipotential surface in a case where a spatial electric field is formed around the installed terminal 10-2 according to the second embodiment. As illustrated in FIG. 11, in the spatial electric field formed by the wearable terminal 20 facing the installed terminal 10-2, due to a difference in thickness between the first electrode plate 126 and the second electrode plate 128, disturbance of the equipotential surface occurs around the first electrode plate 126 and the second electrode plate 128. As a result, an equipotential surface exists between the first electrode plate 126 and the second electrode plate 128. That is, a potential difference is generated between the first electrode plate 126 and the second electrode plate 128. Accordingly, the installed terminal 10-2 and the wearable terminal 20 are spatially coupled to each other, and BAN communication is realized.

In contrast, in a case where the wearable terminal 20 is positioned on the back side of the installed terminal 10-2, disturbance of the equipotential surface on the plane where the first electrode plate 126 and the second electrode plate 128 exist is smaller than that in a case where the wearable terminal 20 is positioned on the front side of the installed terminal 10-2. That is, the potential difference generated between the first electrode plate 126 and the second electrode plate 128 is smaller in a case where the wearable terminal 20 is located on the back side of the installed terminal 10-2. Therefore, in a case where the wearable terminal 20 is located on the back side of installed terminal 10-2, spatial coupling and BAN communication between the wearable terminal 20 and the installed terminal 10-2 are less likely to occur.

FIG. 12 is an explanatory diagram illustrating the relationship between the positional relationship between the installed terminal 10-2 and the wearable terminal 20 and throughput realized by BAN communication. As illustrated in FIG. 12, on the front side of the installed terminal 10-2, high throughput is realized within the range where the distance between the wearable terminal 20 and the installed terminal 10-2 is about within 10 cm. In contrast, on the back side of the installed terminal 10-2, if the distance between the wearable terminal 20 and the installed terminal 10-2 exceeds 2 to 3 cm, throughput sharply decreases.

(Conclusion of Second Embodiment)

As described above, according to the second embodiment, by restricting the occurrence of spatial coupling on the back side of the installed terminal 10-2 while allowing spatial coupling on the front side of the installed terminal 10-2, it is possible to suppress occurrence of BAN communication not intended by the user.

<3. Modification>

The embodiments of the present disclosure have been described above. Hereinafter, some modifications of the embodiments of the present disclosure will be described. Note that each modification described below may be applied alone to the embodiment of the present disclosure, or may be applied to the embodiment of the present disclosure in combination. Furthermore, each modification may be applied in lieu of the configuration described in the embodiment of the present disclosure, or may be additionally applied to the configuration described in the embodiment of the present disclosure.

(First Modification)

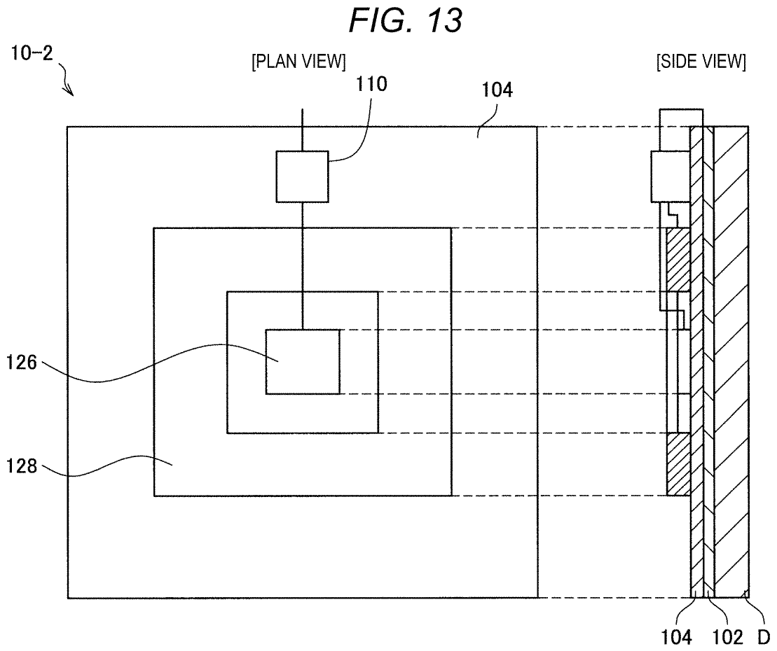

For example, the second embodiment describes an example in which the first electrode plate 126 is thicker than the second electrode plate 128. However, the relationship of the thicknesses of the first electrode plate 126 and the second electrode plate 128 is not limited to the example described above. As illustrated in FIG. 13, even in a case where the thickness of a second electrode plate 128 exceeds the thickness of a first electrode plate 126, similarly to the example illustrated in FIG. 11, it is possible to cause disturbance of an equipotential surface around the first electrode plate 126 and the second electrode plate 128.

(Second Modification)

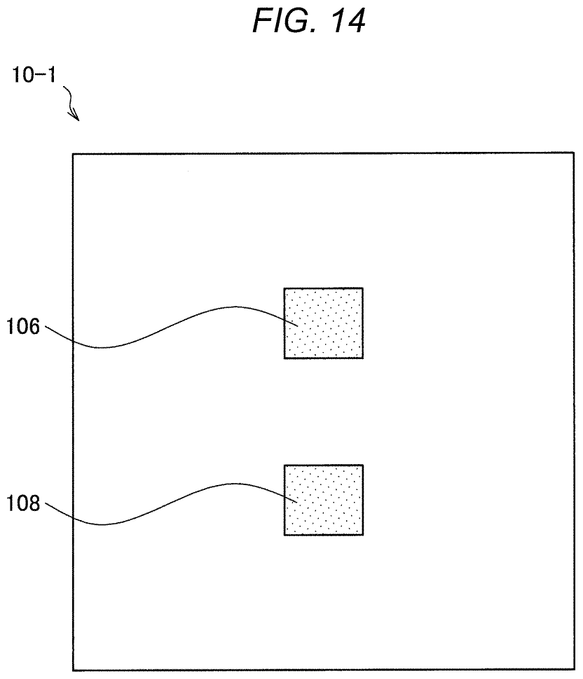

The first embodiment describes an example in which the first electrode plate 106 has a square shape and the second electrode plate 108 has a shape surrounding the first electrode plate 106; however, the configuration of each electrode plate and the positional relationship between the electrodes are not limited to the example described above. For example, a second electrode plate 108 does not necessarily have a shape surrounding the first electrode plate 106. As illustrated in FIG. 14, a first electrode plate 106 and a second electrode plate 108 may have the same square shape in plan view of an installed terminal 10-1. Furthermore, the shape of each electrode plate is not limited to a square, and the shape of each electrode plate may be another shape such as a rectangle, a circle, an ellipse, or a polygon.

<4. Conclusion>

As described above, according to the embodiments of the present disclosure, it is possible to suppress occurrence of BAN communication that is not intended by the user. Furthermore, in the installed terminal 10 according to the embodiments of the present disclosure, since the two electrodes are arranged on the same plane, it is possible to configure the installed terminal 10 as a planar electrode device having a reduced thickness. That is, the embodiments of the present disclosure can suppress occurrence of BAN communication not intended by the user while improving ease of introduction.

Note that while preferred embodiments of the present disclosure have been described in detail with reference to the accompanying drawings, the technical scope of the present disclosure is not limited to such examples. It is obvious that a person skilled in the art of the present disclosure can conceive various modifications and corrections within the scope of the technical idea described in the claims, and it is naturally understood that these modifications and corrections also belong to the technical scope of the present disclosure.

For example, even though the examples in which the installed terminal 10 is installed on the door D of the building H have been described above, the application destination of an installed terminal 10 is not limited to a door D of a building H. For example, an installed terminal 10 can be applied to a settlement device for transport, an entrance/exit gate device for various facilities, or the like.

Furthermore, examples where the installed terminal 10 has two electrodes arranged on the same plane have been described above. However, two electrodes arranged on the same plane may be provided on a wearable terminal 20 side.

Furthermore, the examples in which the shape of each of the conductive plate 102, the first electrode plate 106, and the second electrode plate 108 is a flat-plate shape have been mainly described above. However, the shape of each of a conductive plate 102, a first electrode plate 106, and a second electrode plate 108 may not be a flat-plate shape. For example, the shape of a conductive plate 102 may be a curved shape having a curve. In this case, the shape of each of the first electrode plate 106 and the second electrode plate 108 may be a curved shape having a curvature such that the distances from points on a surface facing the conductor plate 102 to the conductive plate 102 are equal to each other everywhere.

Furthermore, the effects described in the present description are illustrative or exemplary only and are not limited. That is, the technique according to the present disclosure can exhibit other effects that are apparent to those skilled in the art from the description of the present description in addition to or in lieu of the effects described above.

Furthermore, the following configurations also belong to the technical scope of the present disclosure.

(1)

An electrode device including:

a conductive plate;

a first electrode plate provided in parallel with the conductive plate and spaced apart from the conductive plate in the thickness direction of the conductive plate; and

a second electrode plate provided in parallel with the conductive plate, at a location not overlapping with the first electrode plate in the planar direction of the conductive plate.

(2)

The electrode device according to (1), in which the first electrode plate and the second electrode plate are provided so as to overlap with each other in the thickness direction of the conductive plate.

(3)

The electrode device according to (2), in which the first electrode plate and the second electrode plate have the same thicknesses and are provided at the same location in the thickness direction of the conductive plate.

(4)

The electrode device according to (1) or (2), in which the thickness of the first electrode plate differs from the thickness of the second electrode plate.

(5)

The electrode device according to any one of (1) to (4), in which the second electrode plate has a shape surrounding the first electrode plate.

(6)

The electrode device according to any one of (1) to (5), in which the area of the plane of the conductive plate is larger than the area of the plane of the first electrode plate and the area of the plane of the second electrode plate.

(7)

The electrode device according to (6), in which the first electrode plate and the second electrode plate are provided within the range of the plane of the conductive plate.

(8)

The electrode device according to any one of (1) to (7) further including a communication processing unit configured to perform a process regarding human body communication by using a potential difference between the first electrode plate and the second electrode plate.

### REFERENCE SIGNS LIST

10 Installed terminal
20 Wearable terminal
22 Band unit
102 Conductive plate
104 Insulating plate
106 First electrode plate
108 Second electrode plate
110 Communication processing unit
126 First electrode plate
128 Second electrode plate

1. An electrode device comprising:
a conductive plate;
a first electrode plate provided in parallel with the conductive plate and spaced apart from the conductive plate in a thickness direction of the conductive plate; and
a second electrode plate provided in parallel with the conductive plate, at a location not overlapping with the first electrode plate in a planar direction of the conductive plate.

2. The electrode device according to claim 1, wherein the first electrode plate and the second electrode plate are provided so as to overlap with each other in the thickness direction of the conductive plate.

3. The electrode device according to claim 2, wherein the first electrode plate and the second electrode plate have same thicknesses and are provided at a same location in the thickness direction of the conductive plate.

4. The electrode device according to claim 1, wherein a thickness of the first electrode plate differs from a thickness of the second electrode plate.

5. The electrode device according to claim 1, wherein the second electrode plate has a shape surrounding the first electrode plate.

6. The electrode device according claim 1, wherein an area of a plane of the conductive plate is larger than an area of the plane of the first electrode plate and an area of a plane of the second electrode plate.

7. The electrode device according to claim 6, wherein the first electrode plate and the second electrode plate are provided within a range of the plane of the conductive plate.

8. The electrode device according to claim 1 further comprising a communication processing unit configured to perform a process regarding human body communication by using a potential difference between the first electrode plate and the second electrode plate.
